(19) United States
(12) Patent Application Publication
(10) Pub. No.: US 2025/0345927 A1
(43) Pub. Date: Nov. 13, 2025

(54) WEARABLE ROBOT

(71) Applicants: HYUNDAI MOTOR COMPANY, Seoul (KR); KIA CORPORATION, Seoul (KR)

(72) Inventors: Ho Jun Kim, Hwaseong-si (KR); Ju Young Yoon, Hwaseong-si (KR); Moon Ki Jung, Hwaseong-si (KR); Hyun Seop Lim, Hwaseong-si (KR); Kyu Jung Kim, Hwaseong-si (KR)

(73) Assignees: HYUNDAI MOTOR COMPANY, Seoul (KR); KIA CORPORATION, Seoul (KR)

(21) Appl. No.: 18/946,566

(22) Filed: Nov. 13, 2024

(30) Foreign Application Priority Data
May 10, 2024 (KR) 10-2024-0062035

(51) Int. Cl. B25J 9/00

(52) U.S. Cl. CPC B25J 9/0006

(57) ABSTRACT

A wearable robot includes upper and lower body parts configured to be respectively tightly attached to upper and lower bodies of a person. In particular, the upper body part includes: a waist harness member, a middle connection link having one side connected to the lower body part; a harness connection member connected to the waist harness member and the middle connection link; and an upper connection link that includes one side connected to the middle connection link, and a section extending toward a chest of the person. In particular, the harness connection member and the middle connection link are rotatably connected, and the middle connection link and the upper connection link are rotatably connected.

### CROSS-REFERENCE TO RELATED APPLICATION

This application claims priority to and the benefit of Korean Patent Application No. 10-2024-0062035 filed in the Korean Intellectual Property Office on May 10, 2024, the entire contents of which are incorporated herein by reference.

### TECHNICAL FIELD

The present disclosure relates to a wearable robot, and more particularly, to a wearable robot capable of assisting muscular strength of a wearer.

### BACKGROUND

The statements in this section merely provide background information related to the present disclosure and may not constitute prior art.

A wearable robot, which generates assistive power for assisting muscular strength of a wearer's waist, refers to a device that reduces a load applied to the wearer's waist by providing assistive power in a direction in which the wearer's waist is stretched when the wearer bends at the waist. The wearable robots may be classified into a front supporting wearable robot, in which components of the wearable robot, which are tightly attached to the wearer, are tightly attached to a front side of the wearer, i.e., the wearer's chest, and a rear supporting wearable robot in which the components are tightly attached to a rear side of the wearer, i.e., the wearer's back.

Among these wearable robots in the related art, the front supporting wearable robot adopts a structure, which is capable of rotating in a leftward/rightward direction, between a structure worn on a waist region and a structure worn on a lower body region, such that the front supporting wearable robot copes with a rotational motion of the wearer in the leftward/rightward direction (e.g., an operation of the wearer bending at the waist in the leftward/rightward direction or spreading his/her legs).

However, in the related art, there is a problem in that it is difficult for the wearer to perform a rotational motion in the leftward/rightward direction in a plurality of joint regions in a state in which the wearer wears the wearable robot. In other words, in the related art, there is a problem in that significant heterogeneity is imparted to the wearer because of a structural limitation of the wearable robot in case that the wearer bends at the waist in the leftward/rightward direction and simultaneously spreads his/her legs in the state in which the wearer wears the wearable robot.

The statements in this section merely provide background information related to the present disclosure and may not constitute prior art.

### SUMMARY

An object of the present disclosure is to propose a novel structure capable of providing comfort to a wearer even when the wearer performs a rotational motion in a leftward/rightward direction in a plurality of joint regions in a state in which the wearer wears the wearable robot.

In order to achieve the above-mentioned object, one aspect of the present disclosure provides a wearable robot. The wearable robot includes: an upper body part configured to be at least partially tightly attached to an upper body of a person; and a lower body part configured to be at least partially tightly attached to a lower body of the person and connected to the upper body part. In particular, the upper body part includes: a waist harness member configured to be worn on a waist of the person; a middle connection link having one side connected to the lower body part; a harness connection member having a first side connected to the waist harness member and a second side connected to the middle connection link; and an upper connection link having one side connected to the middle connection link. The upper connection link includes a section extending toward a chest of the person. The harness connection member and the middle connection link are connected so as to be rotatable about a first rotation axis A1, and the middle connection link and the upper connection link are connected so as to be rotatable about a second rotation axis A2 that is spaced apart from the first rotation axis A1.

The first rotation axis A1 and the second rotation axis A2 may be parallel to each other.

The first rotation axis A1 may be positioned above the second rotation axis A2.

The first rotation axis A1 may be positioned outward of the second rotation axis A2 in a leftward/rightward direction.

The upper connection link may include: a first upper link member having one side connected to the middle connection link and configured to be rotatable about the second rotation axis A2. In particular, the first upper link member includes a section extending toward the chest of the person. The upper connection link may further include a second upper link member connected to an upper region of the first upper link member, and the second upper link member may be configured to be movable relative to the first upper link member in a direction parallel to a direction in which the first upper link member extends in a region in which the second upper link member and the first upper link member are connected.

The second upper link member may be connected to the first upper link member and configured to be rotatable about a third rotation axis A3 that is parallel to the direction in which the first upper link member extends in the region in which the second upper link member and the first upper link member are connected.

The first upper link member may include a hollow pipe region with an empty interior, and the second upper link member may be inserted into the hollow pipe region.

The first upper link member may include: a first-first upper link region connected to the middle connection link, configured to be rotatable about the first rotation axis A1, and extending forward from the middle connection link; and a first-second upper link region bent and extending upward from the first-first upper link region. The second upper link member may be connected to an upper region of the first-second upper link region.

The upper body part may further include: a chest attachment member configured to be tightly attached to the chest of the person; and an upper rotation mediation link having a first side fixed to the chest attachment member and a second side connected to the second upper link member. The upper rotation mediation link may be rotatably connected to the second upper link member.

The upper rotation mediation link may be connected to the second upper link member and configured to be rotatable about two or more rotation axes A4 and A5.

The two or more rotation axes A4 and A5 may be perpendicular to one another.

Among the two or more rotation axes A4 and A5, one rotation axis A4 may extend in a forward/rearward direction, and another rotation axis A5 may extend in a leftward/rightward direction.

The lower body part may include: an assistive power generation module connected to the middle connection link and configured to generate a rotational restoring force in conjunction with a rotation angle between the upper body part and the lower body part; a lower connection link connected to one side of the assistive power generation module; and a thigh attachment member provided at one side of the lower connection link and configured to be tightly attached to a thigh of the person. The thigh attachment member may be rotatably connected to the lower connection link.

The thigh attachment member may be connected to the lower connection link and configured to be rotatable about two or more rotation axes A6 and A7.

The two or more rotation axes A6 and A7 may be perpendicular to one another.

One rotation axis A6, among the two or more rotation axes A6 and A7, may extend in a forward/rearward direction, and another rotation axis A7 may extend in a leftward/rightward direction.

The lower connection link may be fixedly coupled to the assistive power generation module.

The lower connection link may be connected to the assistive power generation module and configured to be rotatable about a rotation axis A8.

The wearable robot may include: a left wearable robot configured to be worn on a left side of the person; and a right wearable robot configured to be worn on a right side of the person, in which the left wearable robot and the right wearable robot are configured as separate components.

According to the present disclosure, it is possible to provide comfort to the wearer even in case that the wearer performs a rotational motion in the leftward/rightward direction in the plurality of joint regions in a state in which the wearer wears the wearable robot.

### BRIEF DESCRIPTION OF THE DRAWINGS

FIG. 1 is a view illustrating a state in which a person wears a wearable robot according to an embodiment of the present disclosure.

FIG. 2 is a perspective view illustrating the wearable robot according to an embodiment of the present disclosure.

FIG. 3 is an enlarged view illustrating a region in which an upper body part and a lower body part of the wearable robot according to the present disclosure are connected when viewed from the rear side.

FIG. 4 is an enlarged view illustrating the region in which the upper body part and the lower body part of the wearable robot according to the present disclosure are connected when viewed from the front side.

FIG. 5 is an enlarged view illustrating an upper connection link of the upper body part and surrounding components thereof provided in the wearable robot according to an embodiment of the present disclosure.

FIG. 6 is an enlarged view illustrating a chest attachment member of the upper body part and surrounding components thereof provided in the wearable robot according to an embodiment of the present disclosure.

FIG. 7 is a view illustrating an assistive power generation module, a lower connection link, and a thigh attachment member provided in the wearable robot according to an embodiment of the present disclosure.

FIG. 8 is an enlarged view illustrating a region in which the lower connection link and the thigh attachment member in FIG. 7 are connected.

The drawings described herein are for illustration purposes only and are not intended to limit the scope of the present disclosure in any way.

### DETAILED DESCRIPTION

When a component, device, element, or the like of the present disclosure is described as having a purpose or performing an operation, function, or the like, the component, device, or element should be considered herein as being “configured to” meet that purpose or to perform that operation or function.

Hereinafter, a wearable robot 10 according to an embodiment of the present disclosure is described with reference to the drawings.

### Wearable Robot

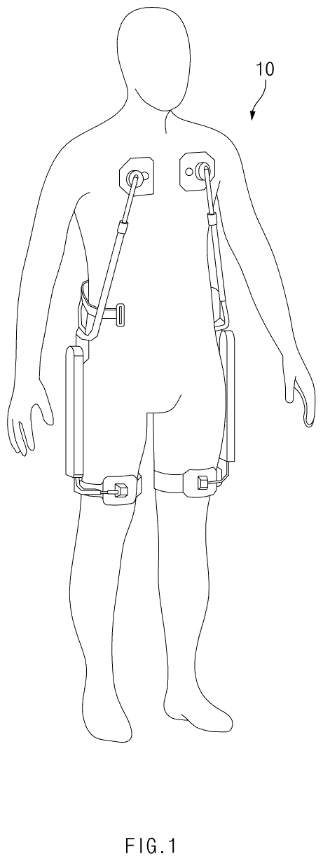

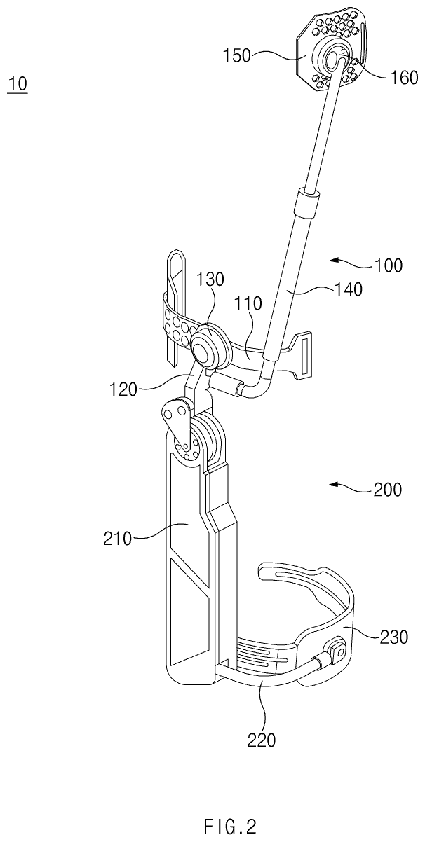

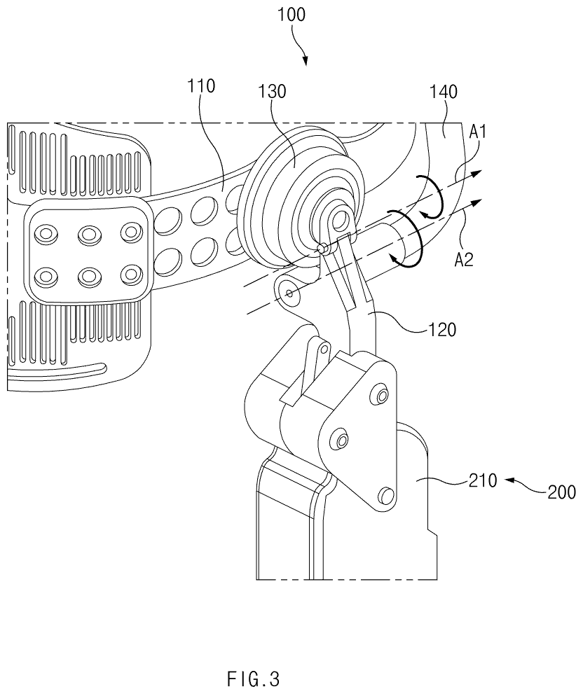

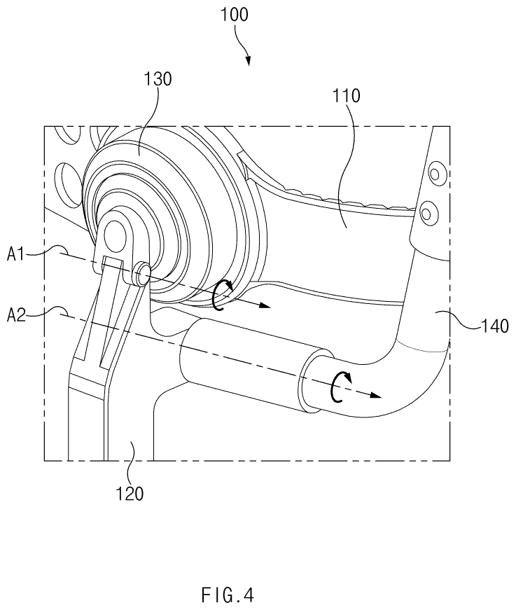

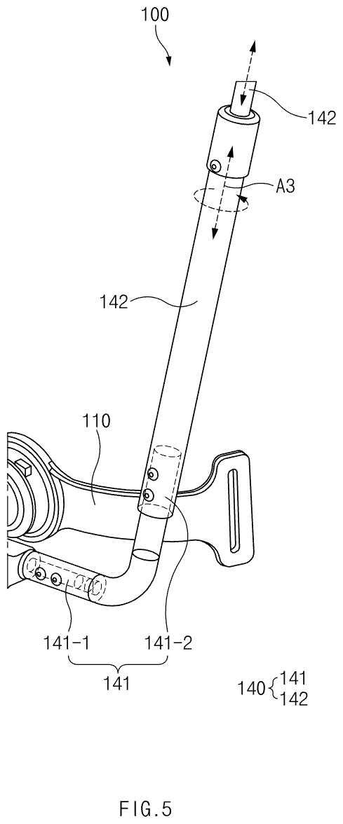

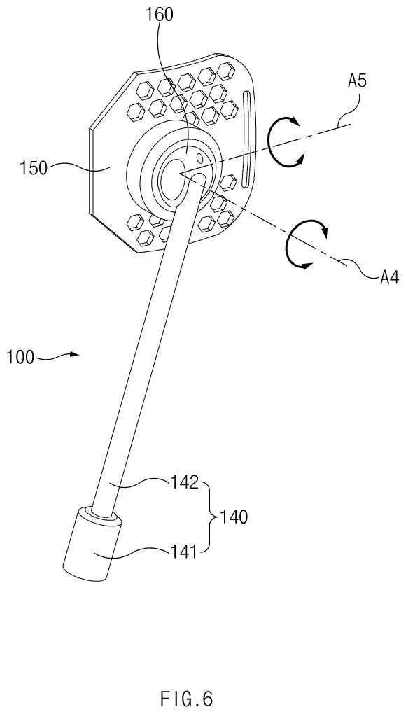

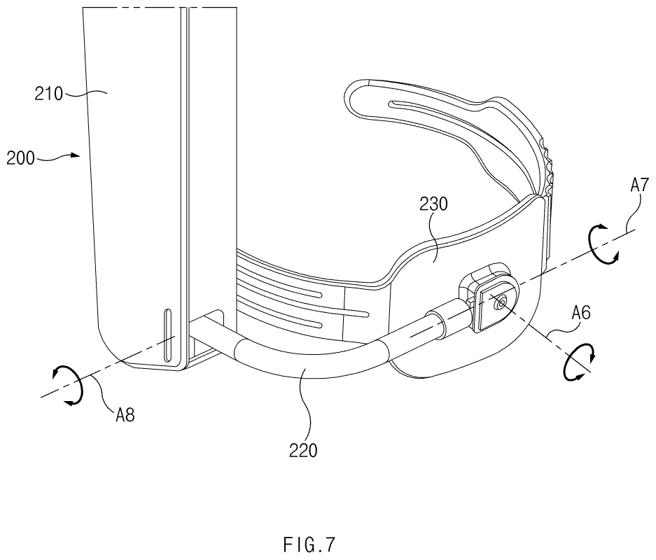

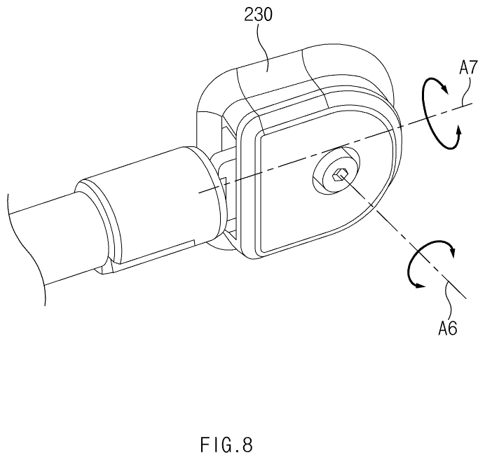

FIG. 1 is a view illustrating a state in which a person wears a wearable robot according to an embodiment of the present disclosure, and FIG. 2 is a perspective view illustrating the wearable robot according to the present disclosure. FIG. 3 is an enlarged view illustrating a region in which an upper body part and a lower body part of the wearable robot according to the present disclosure are connected when viewed from the rear side, and FIG. 4 is an enlarged view illustrating the region in which the upper body part and the lower body part of the wearable robot according to the present disclosure are connected when viewed from the front side. FIG. 5 is an enlarged view illustrating an upper connection link of the upper body part and surrounding components thereof provided in the wearable robot according to the present disclosure, and FIG. 6 is an enlarged view illustrating a chest attachment member of the upper body part and surrounding components thereof provided in the wearable robot according to the present disclosure. FIG. 7 is a view illustrating an assistive power generation module, a lower connection link, and a thigh attachment member provided in the wearable robot according to the present disclosure, and FIG. 8 is an enlarged view illustrating a region in which the lower connection link and the thigh attachment member in FIG. 7 are connected.

The wearable robot according to the present disclosure may serve to provide assistive power for assisting muscular strength of a person. For example, the wearable robot according to the present disclosure may provide assistive power for assisting muscular strength of a person's waist. For example, when a person wearing the wearable robot bends at the waist, it may generate assistive power in a direction that stretches the person's waist. Hereinafter, in the present specification, the wearable robot according to the present disclosure is described based on a state in which the person stands after wearing the wearable robot in accordance with the functions and purposes of the wearable robot. More specifically, in the present specification, a forward/rearward direction, a leftward/rightward direction, and an upward/downward direction of the person, who wears the wearable robot, are respectively defined as a forward/rearward direction, a leftward/rightward direction, and an upward/downward direction of the wearable robot.

With reference to FIGS. 1 and 2, the wearable robot 10 according to the present disclosure may include an upper body part 100 configured to be at least partially tightly attached to an upper body of the person, and a lower body part 200 configured to be at least partially tightly attached to a lower body of the person and connected to the upper body part 100. The upper body part 100 and the lower body part 200 of the wearable robot 10 may be configured to be rotatable in the forward/rearward direction relative to each other. More specifically, when the person bends at the waist in the state in which the person wears the wearable robot 10, the upper body part 100 may rotate forward, such that the lower body part 200 may generate assistive power in a direction opposite to a direction in which the upper body part 100 rotates, i.e., a direction in which the lower body part 200 rotates rearward.

With reference to FIGS. 3 and 4, the upper body part 100 of the wearable robot 10 may include a waist harness member 110 configured to be worn on a person's waist, a middle connection link 120 having one side connected to the lower body part 200, and a harness connection member 130 having one side connected to the waist harness member 110 and the other side connected to the middle connection link 120. The upper body part 100 may further include an upper connection link 140 having one side connected to the middle connection link 120 and including a section extending toward the person's chest. The waist harness member 110 may have a shape that surrounds the person's waist, and the harness connection member 130 may be configured to mediate between the waist harness member 110 and the middle connection link 120. For example, the harness connection member 130 may include a first region fixed to the waist harness member 110, and a second region fixed to the middle connection link 120. The first region and the second region may be coupled to be repeatedly attached or detached by means of a ratchet member or the like.

The middle connection link 120 and the harness connection member 130 may be provided to face lateral portions of the waist and hip joint of the person based on the leftward/rightward direction. In addition, the middle connection link 120 may be provided on a lower portion of the harness connection member 130.

Meanwhile, the upper connection link 140 may be a component extending from the middle connection link 120. When the person wears the wearable robot 10, the upper connection link 140 may be positioned at a front side of the person's upper body portion.

Meanwhile, the upper body part 100 of the wearable robot 10 according to the present disclosure may be configured to be rotatable not only in the forward/rearward direction but also in the leftward/rightward direction relative to the lower body part 200. Therefore, according to the present disclosure, the person may smoothly bend at the waist in the leftward/rightward direction in the state in which the person wears the wearable robot 10.

In particular, the wearable robot 10 according to the present disclosure may have a structure that may not provide heterogeneity to the person even in case that the person performs a motion involving a more complex rotation of a joint in the leftward/rightward direction, such as a case in which the person bends at the waist in the leftward/rightward direction in the state in which the person spreads the legs.

In order to achieve the above-mentioned object, according to the present disclosure, as illustrated in FIGS. 3 and 4, the harness connection member 130 and the middle connection link 120 may be connected to be rotatable about a first rotation axis A1, and the middle connection link 120 and the upper connection link 140 may be connected to be rotatable about a second rotation axis A2 spaced apart from the first rotation axis A1. That is, according to the present disclosure, two or more regions of the upper body part 100 may perform rotational motions.

In particular, according to the present disclosure, because the middle connection link 120 and the harness connection member 130 are provided to face the lateral portions of the waist and hip joint of the person based on the leftward/rightward direction as described above, the two or more regions of the upper body part 100, which are adjacent to the waist and hip joint of the person, may perform the rotational motions in accordance with the posture of the person.

For example, as illustrated in FIGS. 3 and 4, the first rotation axis A1 and the second rotation axis A2 may be defined in parallel with each other, and the first rotation axis A1 may be defined above the second rotation axis A2. For example, the first rotation axis A1 and the second rotation axis A2 may be provided to face the waist and hip joint of the person in the leftward/rightward direction.

According to the present disclosure, when the person wearing the wearable robot 10 spreads the legs, the middle connection link 120 may rotate about the first rotation axis A1 relative to the harness connection member 130, and a relative rotational motion between the middle connection link 120 and the upper connection link 140 may also be performed about the second rotation axis A2 in conjunction with the rotational motion of the middle connection link 120. More particularly, as illustrated in FIGS. 3 and 4, the first rotation axis A1 may be defined outward of the second rotation axis A2 based on the leftward/rightward direction.

Meanwhile, with reference to FIGS. 5 and 6, the upper connection link 140 provided in the upper body part 100 may include a plurality of members. More specifically, the upper connection link 140 may include a first upper link member 141 having one side connected to the middle connection link 120 and configured to be rotatable about the second rotation axis A2, and a second upper link member 142 connected to an upper region of the first upper link member 141. The first upper link member 141 includes a section extending toward the person's chest. For example, the second upper link member 142 may have an approximately straight rod shape.

In one embodiment of the present disclosure, the first upper link member 141 and the second upper link member 142 may be configured to perform both translational and rotational motions relative to each other. More specifically, the second upper link member 142 may be configured to move relative to the first upper link member 141 (i.e., perform a translational motion) in a direction parallel to the direction in which the first upper link member 141 extends in a region in which the second upper link member 142 and the first upper link member 141 are connected. In addition, the second upper link member 142 may be connected to the first upper link member so as to be rotatable about a rotation axis A3 (hereinafter, referred to as a ‘third rotation axis’), which is parallel to the direction in which the first upper link member 141 extends in the region in which the second upper link member 142 and the first upper link member 141 are connected.

For example, as illustrated in FIGS. 5 and 6, the first upper link member 141 may include a hollow pipe region with an empty interior, and the second upper link member 142 may be inserted into the hollow pipe region. In this case, the second upper link member 142 may perform a translational motion parallel to a direction in which the hollow pipe region of the first upper link member 141 extends (a direction obliquely extending upward as shown in FIGS. 5 and 6). The second upper link member 142 may rotate about the third rotation axis A3 defined in the hollow pipe region and provided in parallel with the direction in which the hollow pipe region extends.

With continued reference to FIGS. 4 and 5, the first upper link member 141 may have a curved or bent shape. More specifically, the first upper link member 141 may include a first-first upper link region 141-1 that is connected to the middle connection link 120 and configured to be rotatable about the second rotation axis A2. In particular, the first-first upper link region 141-1 may extend forward from the middle connection link 120. The first upper link member 141 may further include a first-second upper link region 141-2 that is curved or bent and extends upward from the first-first upper link region 141-1. In this case, the second upper link member 142 may be connected to an upper region of the first-second upper link region 141-2. More specifically, the hollow pipe region may be provided in the first-second upper link region 141-2, and the second upper link member 142 may be inserted into the first-second upper link region 141-2.

In another embodiment, with reference to FIGS. 5 and 6, the upper body part 100 of the wearable robot 10 may further include: a chest attachment member 150 configured to be tightly attached to the person's chest, and an upper rotation mediation link 160 fixed to the chest attachment member 150 and having the other side connected to the second upper link member 142. In one embodiment, the upper rotation mediation link 160 may be rotatably connected to the second upper link member 142. In this case, the chest attachment member 150 may rotate in accordance with a change in posture of the person, which helps prevent the chest attachment member 150 from excessively pressing the person's chest.

More specifically, the upper rotation mediation link 160 may be connected to the second upper link member 142 and configured to be rotatable about two or more rotation axes A4 and A5. More particularly, the two or more rotation axes A4 and A5 may be perpendicular to one another. For example, one rotation axis (A4, hereinafter, referred to as a ‘fourth rotation axis’), among the two or more rotation axes A4 and A5, may extend in the forward/rearward direction, and another rotation axis (A5, hereinafter, referred to as a ‘fifth rotation axis’) of the two or more rotation axes A4 and A5 may extend in the leftward/rightward direction.

In another embodiment, with reference to FIGS. 1, 2, and 7, the lower body part 200 of the wearable robot 10 may further include an assistive power generation module 210 configured to generate a rotational restoring force in conjunction with a rotation angle between the upper body part 100 and the lower body part 200, and the assistive power generation module 210 is connected to the middle connection link 120. More specifically, when the person bends at the waist, a relative rotational motion may occur between the upper body part 100 and the lower body part 200. Therefore, the middle connection link 120 may also perform a rotational motion relative to the assistive power generation module 210, and a portion of the assistive power generation module 210 connected to the middle connection link 120 may perform a rotational motion relative to another portion of the assistive power generation module 210 in conjunction with the rotational motion of the middle connection link 120. Therefore, the assistive power generation module 210 may generate a rotational restoring force, which is applied in a direction opposite to the direction in which the middle connection link 120 performs the rotational motion, and the assistive power generation module 210 may transmit the rotational restoring force to the middle connection link 120. For example, in order to generate the rotational restoring force, the assistive power generation module 210 may include an elastic member (not illustrated) or the like configured to be elastically deformed in conjunction with the rotational motion of the middle connection link 120.

In another embodiment, with reference to FIG. 7, the lower body part 200 of the wearable robot 10 may further include a lower connection link 220 connected to one side of the assistive power generation module 210. For example, FIG. 7 illustrates a state in which the lower connection link 220 is connected to a lower region of the assistive power generation module 210.

In one embodiment, the lower body part 200 may further include a thigh attachment member 230 provided at one side of the lower connection link 220 and configured to be tightly attached to the person's thigh. The thigh attachment member 230 may be supported by the person's thigh, and the chest attachment member 150 may be supported by the person's chest. Therefore, in case that the person bends at the waist, a relative rotational motion of the upper body part 100 relative to the lower body part 200 may also occur by a supporting force of the chest attachment member 150 applied to the person's chest and a supporting force of the thigh attachment member 230 applied to the person's thigh.

More specifically, according to the present disclosure, the thigh attachment member 230 may be connected to the lower connection link 220 and configured to be rotatable about two or more rotation axes A6 and A7. For example, the two or more rotation axes A6 and A7 may be perpendicular to one another. For example, as illustrated in FIGS. 7 and 8, one rotation axis (A6, hereinafter, referred to as a ‘sixth rotation axis’), among the two or more rotation axes A6 and A7, may extend in the forward/rearward direction. Another rotation axis (A7, hereinafter, referred to as a ‘seventh rotation axis’), among the two or more rotation axes A6 and A7, may extend in the leftward/rightward direction. A relative positional relationship between the thigh attachment member 230 and the lower connection link 220 may vary depending on the change in posture of the person in case that the thigh attachment member 230 is rotatably connected to the lower connection link 220, which may prevent the thigh attachment member 230 from excessively pressing the person's thigh.

In one embodiment of the present disclosure, the wearable robot 10 may include a left wearable robot configured to be worn on a left side of the person, and a right wearable robot configured to be worn on a right side of the person. In this case, the left wearable robot and the right wearable robot, which are configured to be worn on the person, may be configured as separate components. The configuration in which the two wearable robots are configured as separate components may mean that the two wearable robots are spaced apart from each other without being physically connected. In addition, for example, according to the present disclosure, the left wearable robot and the right wearable robot may have symmetric shapes with respect to the person. However, because the two wearable robots are not physically connected as described above, the change in posture of one of the two wearable robots may not directly affect the change in posture of the other wearable robot.

The present disclosure has been described with reference to the limited embodiments and the drawings, but the present disclosure is not limited thereby. The present disclosure may be carried out in various forms by those having ordinary skill in the art, to which the present disclosure pertains, within the technical spirit of the present disclosure and the scope equivalent to the appended claims.

What is claimed is:

1. A wearable robot comprising:
an upper body part configured to be at least partially tightly attached to an upper body of a person; and
a lower body part configured to be at least partially tightly attached to a lower body of the person and connected to the upper body part,
wherein the upper body part comprises:
a waist harness member configured to be worn on a waist of the person;
a middle connection link having one side connected to the lower body part;
a harness connection member including: a first side connected to the waist harness member, and a second side connected to the middle connection link; and
an upper connection link including: one side connected to the middle connection link, and a section extending toward a chest of the person,
wherein the harness connection member and the middle connection link are connected so as to be rotatable about a first rotation axis, and
wherein the middle connection link and the upper connection link are connected so as to be rotatable about a second rotation axis that is spaced apart from the first rotation axis.

2. The wearable robot of claim 1, wherein the first rotation axis and the second rotation axis are parallel to each other.

3. The wearable robot of claim 1, wherein the first rotation axis is positioned above the second rotation axis.

4. The wearable robot of claim 1, wherein the first rotation axis is positioned outward of the second rotation axis in a leftward/rightward direction.

5. The wearable robot of claim 1, wherein the upper connection link comprises:
a first upper link member having one side connected to the middle connection link and configured to be rotatable about the second rotation axis; and
a second upper link member connected to an upper region of the first upper link member, and
wherein, the first upper link member includes a section extending toward the chest of the person, and
wherein the second upper link member is configured to be movable relative to the first upper link member in a direction parallel to a direction in which the first upper link member extends in a region in which the second upper link member and the first upper link member are connected.

6. The wearable robot of claim 5, wherein the second upper link member is connected to the first upper link member and configured to be rotatable about a third rotation axis that is parallel to the direction in which the first upper link member extends in the region in which the second upper link member and the first upper link member are connected.

7. The wearable robot of claim 5, wherein the first upper link member comprises a hollow pipe region with an empty interior, and the second upper link member is inserted into the hollow pipe region.

8. The wearable robot of claim 5, wherein the first upper link member comprises:
a first-first upper link region connected to the middle connection link, configured to be rotatable about the first rotation axis, and extending forward from the middle connection link; and
a first-second upper link region bent and extending upward from the first-first upper link region, and
wherein the second upper link member is connected to an upper region of the first-second upper link region.

9. The wearable robot of claim 5, wherein the upper body part further comprises:
a chest attachment member configured to be tightly attached to the chest of the person; and
an upper rotation mediation link having a first side fixed to the chest attachment member and a second side connected to the second upper link member, and
wherein the upper rotation mediation link is rotatably connected to the second upper link member.

10. The wearable robot of claim 9, wherein the upper rotation mediation link is connected to the second upper link member and configured to be rotatable about two or more rotation axes.

11. The wearable robot of claim 10, wherein the two or more rotation axes are perpendicular to one another.

12. The wearable robot of claim 10, wherein among the two or more rotation axes, one rotation axis extends in a forward/rearward direction, and another rotation axis extends in a leftward/rightward direction.

13. The wearable robot of claim 1, wherein the lower body part comprises:
an assistive power generation module connected to the middle connection link and configured to generate a rotational restoring force in conjunction with a rotation angle between the upper body part and the lower body part;
a lower connection link connected to one side of the assistive power generation module; and
a thigh attachment member provided at one side of the lower connection link and configured to be tightly attached to a thigh of the person, and
wherein the thigh attachment member is rotatably connected to the lower connection link.

14. The wearable robot of claim 13, wherein the thigh attachment member is connected to the lower connection link and configured to be rotatable about two or more rotation axes.

15. The wearable robot of claim 14, wherein the two or more rotation axes are perpendicular to one another.

16. The wearable robot of claim 14, wherein among the two or more rotation axes, one rotation axis extends in a forward/rearward direction, and another rotation axis extends in a leftward/rightward direction.

17. The wearable robot of claim 13, wherein the lower connection link is fixedly coupled to the assistive power generation module.

18. The wearable robot of claim 13, wherein the lower connection link is connected to the assistive power generation module and configured to be rotatable about a rotation axis.

19. The wearable robot of claim 1, further comprising:
a left wearable robot configured to be worn on a left side of the person; and
a right wearable robot configured to be worn on a right side of the person,
wherein the left wearable robot and the right wearable robot are configured as separate components.
